(19) United States
(12) Patent Application Publication
(10) Pub. No.: US 2005/0127548 A1
(43) Pub. Date: Jun. 16, 2005

(54) In-mold foaming method for making soles

(76) Inventors: Liu Kuang Hong, Jung He City (TW); Ma Chih Hung, Miau Li Hsien (TW); Tsai Yung-Jen, Chang Hwa Hsien (TW)

Correspondence Address: CHARLES E. BAXLEY, ESQ., 90 JOHN STREET, THIRD FLOOR, NEW YORK, NY, 10038, US

(21) Appl. No.: 10/734,539

(22) Filed: Dec. 12, 2003

(51) Int. Cl. B29C 44/02

(52) U.S. Cl. 264/51

(57) ABSTRACT

The present invention is to provide an in-mold foaming method for making sole, with which the sole can be produced quickly and easily, which includes the procedures as 1) inputting foaming material in mold, wherein a volume percentage of foaming material in cavity of the mold is pre-calculated based on pre-designed specific gravity; 2) in-mold foaming; 3) cooling the foamed sole; 4) semi-finished product of sole is completed. With the procedures 1) inputting foaming material in mold and 2) in-mold foaming, the procedures of air-circulating oven post-cure, cooling and cutting procedures can be omitted, so as to simplify the technical process and improve the working efficiency.

### BACKGROUND OF THE INVENTION

1. Field of the Invention

The present invention relates to an in-mold foaming method for making soles, and more particularly to a production technology which is used for producing soles of shoes.

2. Description of the Prior Arts

Conventional foaming method for making foamed soles, as shown in FIG. 1, includes the procedures as: 1) material foaming with conventional method 2) first cooling step 3) air-circulating oven post-cure step 4) second cooling step 5) cutting foamed soles into desired shape 6) semi-finished products. This conventional foaming method has been applied for long time, but it still has some drawbacks need to be improved as follows:
First, the procedure 1) material foaming with conventional method must put the pre-shaped raw material (such as board, pillar or block-like shape) into the hot pressed mold for foaming. Then the foamed part is cooled down (procedure 2). And then it should be processed in the air-circulating oven for post-cure process (procedure 3) and cooled down again (procedure 4), the semi-finished product is finally achieved. There are too many procedures to produce the foamed sole and each procedure requires different equipment, therefore, the conventional foaming method is too complicated and the production cost is too high.
Second, it is too much time-consuming that the air-circulating oven post-cure procedure 3) requires 4 working hours.
Third, the procedure 5) cutting into desired shape means die-cutting the semi-finished sole into designed size by die-cut stamp, so a great number of wastes (about 20% of the material) will be produced during this procedure, producer has to additionally set up recovery devices for recovering the wastes, and thus the production cost is increased.
Fourth, after the procedure 5), the periphery of the sole (50) will be cut into a plane (51) (as shown in FIG. 2), so with the conventional method the sole cannot be simultaneously formed with high sidewall or periphery structural pattern during the foaming procedure, additional procedures should be set up for producing the high sidewall or periphery structural pattern of the sole. Thereby, the cost is creased again.

The present invention has arisen to mitigate and/or obviate the afore-described disadvantages of the conventional foaming method for making sole.

### SUMMARY OF THE INVENTION

The primary object of the present invention is to provide an in-mold foaming method for making sole, with which the sole can be produced quickly and easily, which includes the procedures as 1) inputting foaming material in mold, wherein a volume percentage of foaming material in the mold cavity is pre-calculated based on pre-designed specific gravity; 2) in-mold foaming; 3) cooling the foamed sole; 4) semi-finished product of sole is completed. With the procedures 1) inputting foaming material in mold and 2) in-mold foaming, the procedures of air-circulating oven post-cure, second cooling and cutting procedures can be omitted, so as to simplify the technical method and improve the working efficiency.

The secondary object of the present invention is to provide an in-mold foaming method for making sole which is able to save the cost for wastes recovery devices.

The further object of the present invention is to provide an in-mold foaming method for making sole which can synchronously produce the sole with high sidewall and periphery structural pattern (without cutting the periphery of the sole).

The present invention will become more obvious from the following description when taken in connection with the accompanying drawings, which shows, for purpose of illustrations only, the preferred embodiment in accordance with the present invention.

### BRIEF DESCRIPTION OF THE DRAWINGS

FIG. 1 is a flow chart for conventional foaming method for making sole;

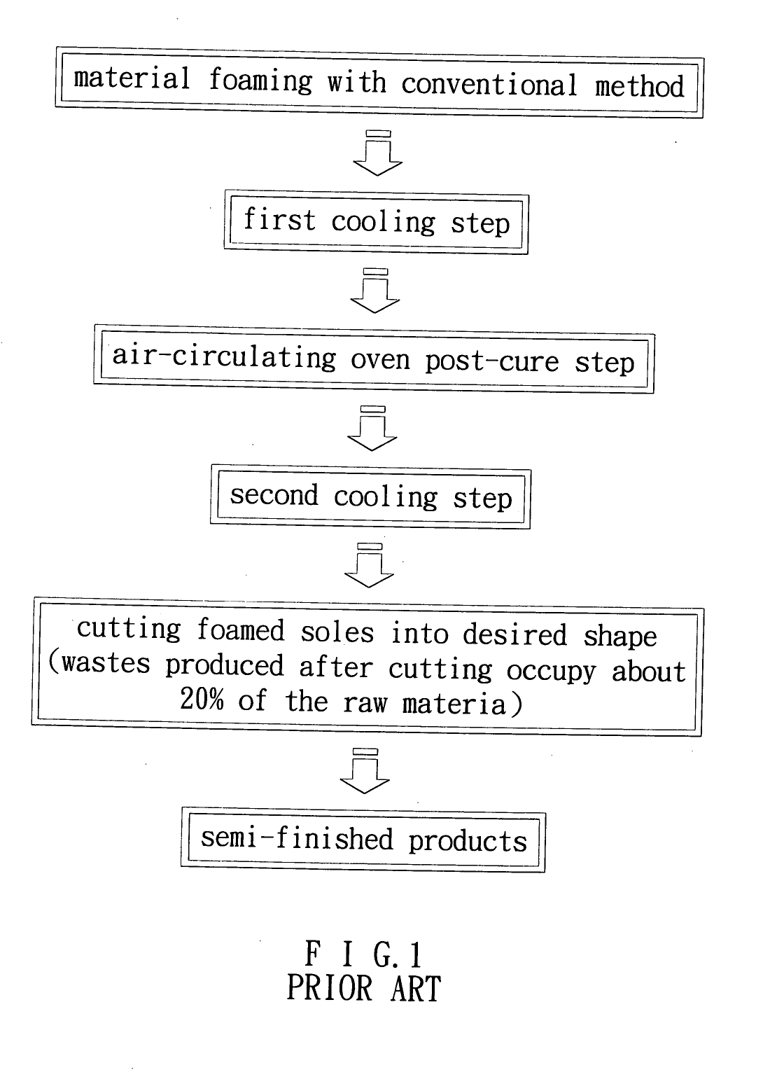

FIG. 2 is a perspective view of a conventional foamed sole;

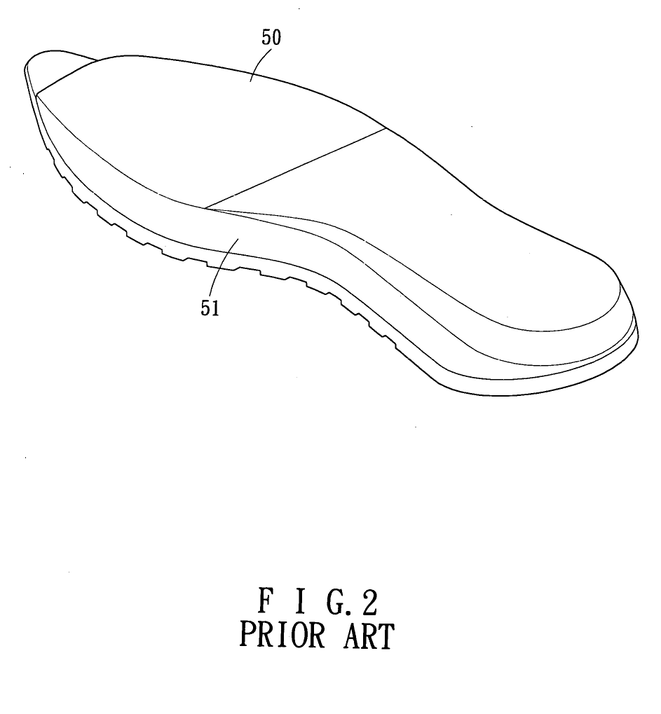

FIG. 3 is a flow chart of an in-mold foaming method in accordance with the present invention;

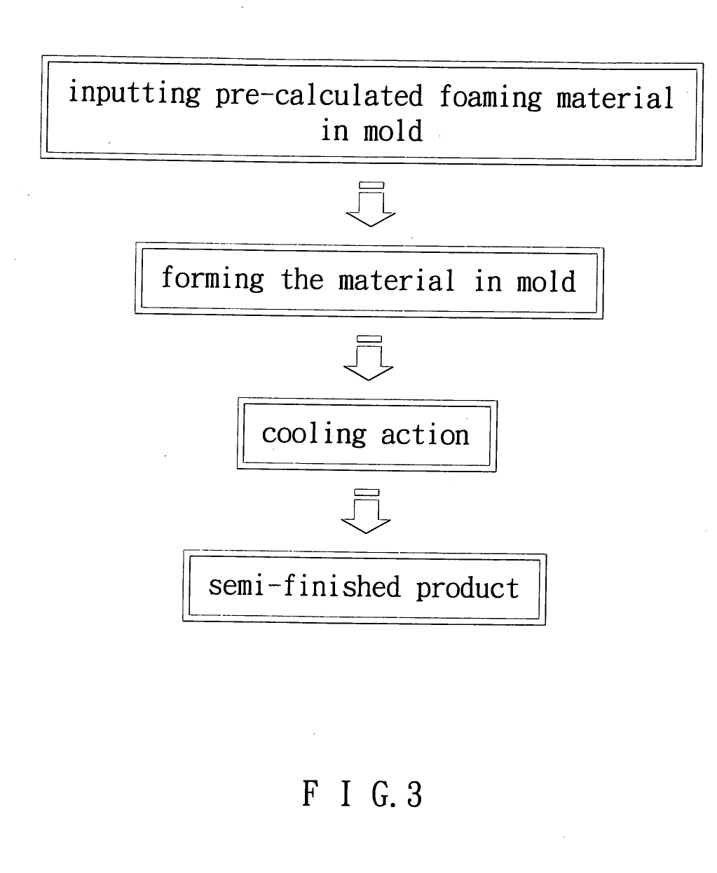

FIG. 4 is a flow chart of an in-mold foaming method in accordance with an embodiment of the present invention;

FIG. 5 is an illustrative view in accordance with an embodiment of the present invention of showing the special portions of the sole;

FIG. 6 is an illustrative view in accordance with an embodiment of the present invention of showing the foaming materials being put into the mold cavity;

FIG. 7 is an illustrative view in accordance with an embodiment of the present invention of showing the foaming materials is forming the mold;

FIG. 8 is a perspective view of a sole in accordance with an embodiment of the present invention.

### DETAILED DESCRIPTION OF THE PREFERRED EMBODIMENTS

The in-mold foaming method for making soles in accordance with the present invention includes the procedures as follows:
1) Inputting rubber-foaming material into mold, wherein the rubber-foaming material occupies 85% of the volume of the mold cavity, the volume percent is pre-calculated accurately based on the pre-designed specific gravity of the semi-finished sole.
2) Foaming the rubber material in the mold for 4-8 minutes at centigrade 140-150 deg, under pressure 130-150 kg/cm², so as to allow the sole to form directly in the mold cavity, and the high sidewall or the periphery structural pattern also can be formed synchronously during foaming procedure.
3) Opening the mold and taking the foamed sole out, so as to cool the sole.
4) Semi-finished product of sole is completed.

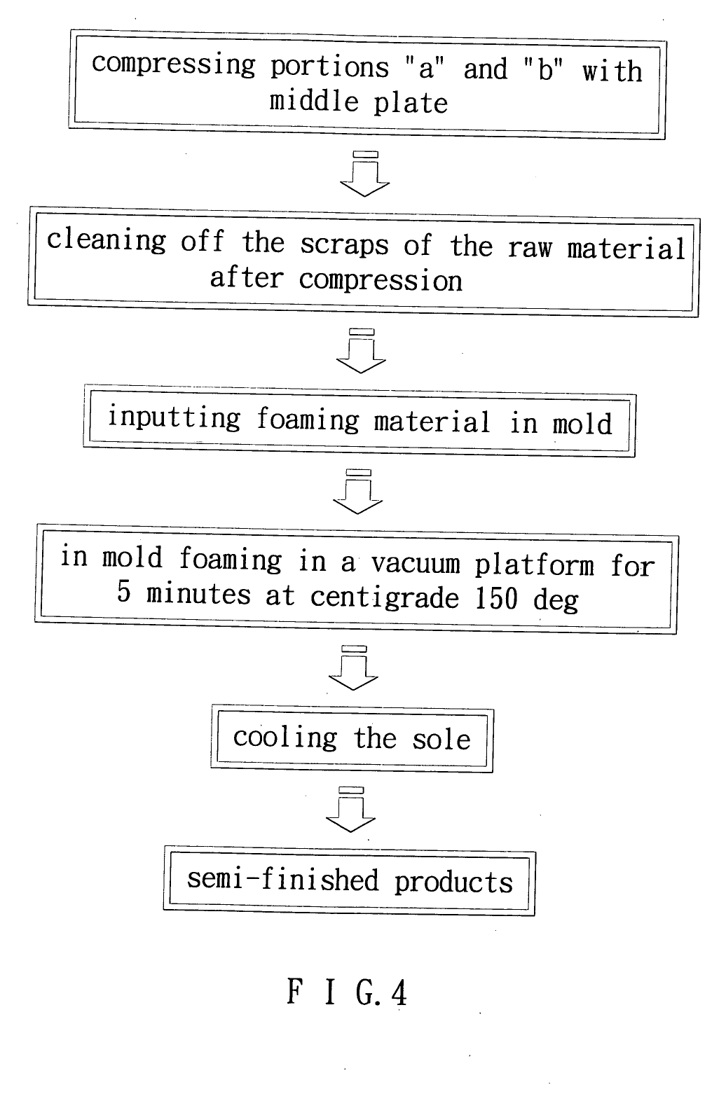

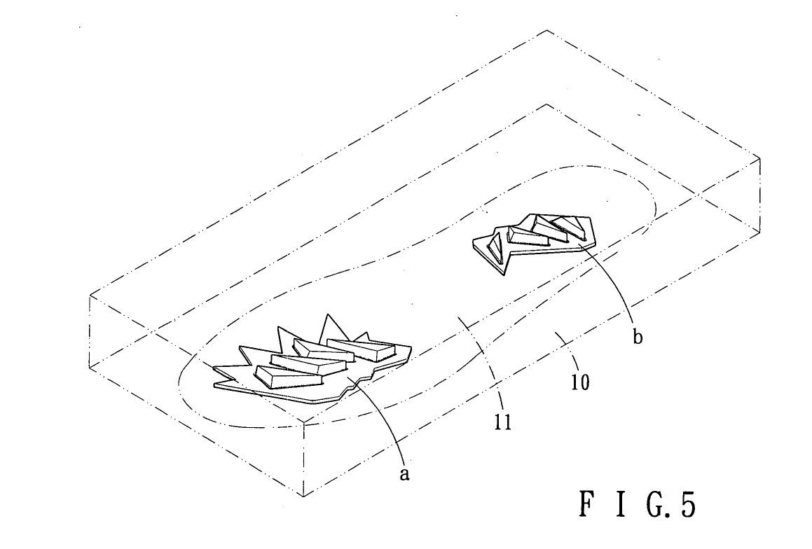

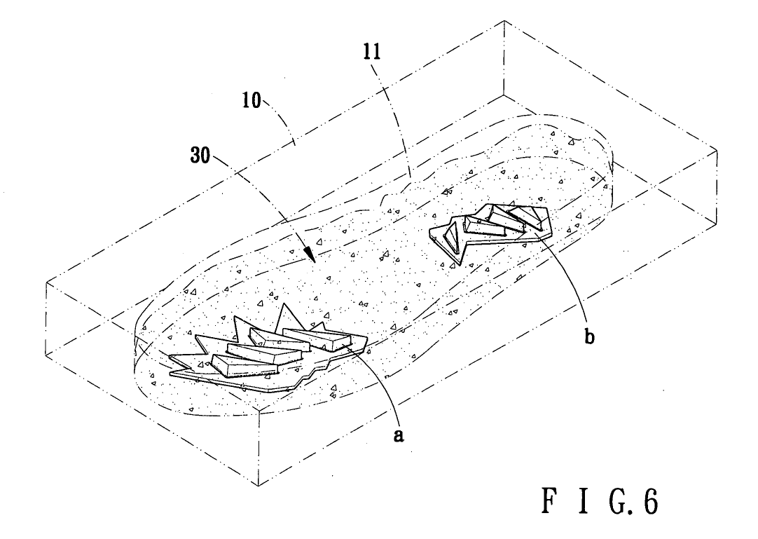

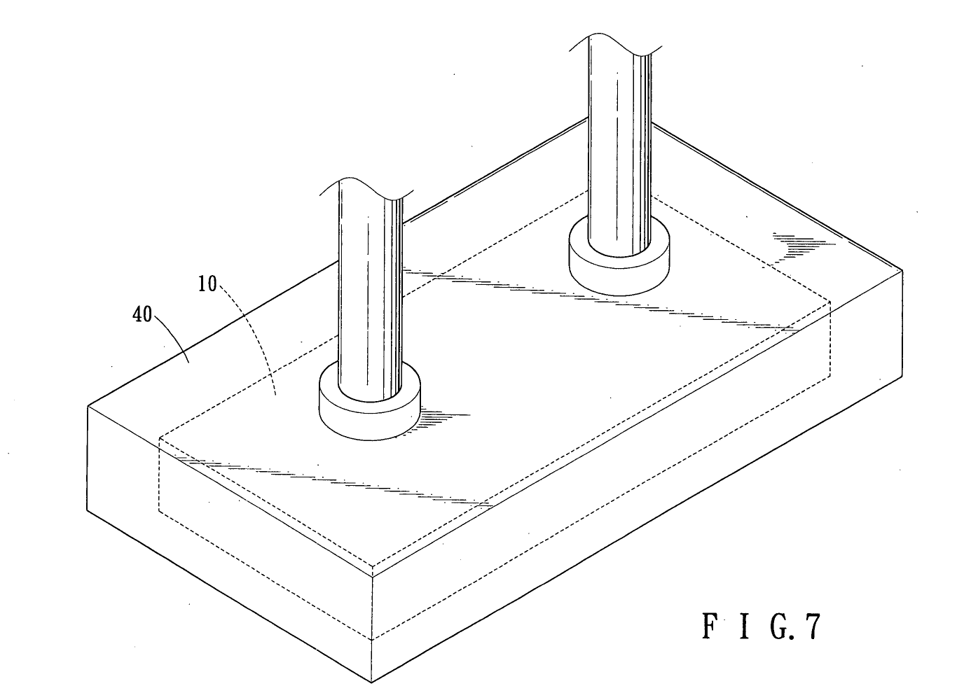

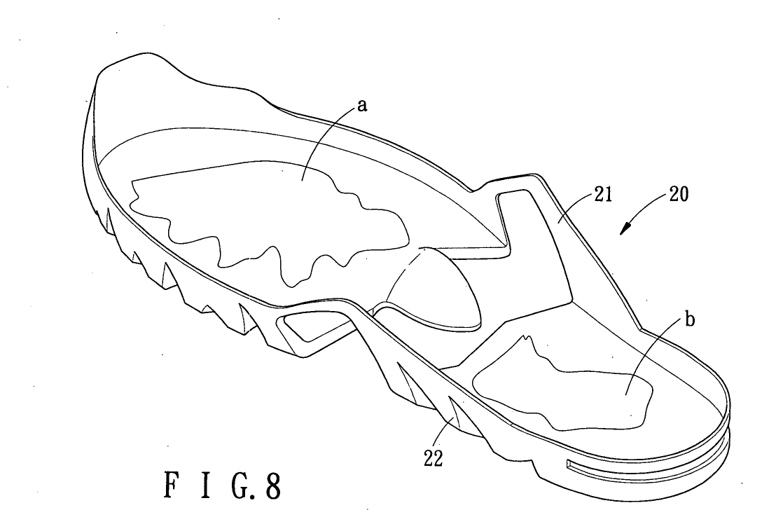

Referring to FIGS. 4-8, wherein FIG. 4 is a flow chart in accordance with the present invention for illustrating the procedures of making the sole, which inludes:
1) Compressing portions “a” and “b” with middle plate: with reference to FIG. 5, wherein the middle plate of the mold is initially used to compress the special portions where preinstalled with raw material (portions “a” and “b”) into a cavity 11 of the mold 10.
2) Cleaning off the scraps of the raw material after compression: Clean scraps of raw material off the mold 10 after portions “a” and “b” have been compressed.
3) Inputting foaming material into mold: with reference to FIG. 6, wherein the rubber-foaming material 30 is put into the cavity 11 of the mold 10, which occupies 85% volume of the mold cavity, the volume percent 85% is for exemplary purposes only in this embodiment and which is pre-calculated accurately based on specific gravity of the pre-designed semi-finished sole.
4) In-mold foaming: as shown in FIGS. 7 and 8, in which, the rubber material 30 is foaming in a vacuum platform 40 for 5 minutes at centigrade 150 deg under pressure 130-150 kg/cm², such that semi-finished product of sole 20 with high sidewall 21 and periphery structural pattern 22 is directly formed in the cavity 11 of the mold 10, and the semi-finished product of sole 20 is integrally formed with the portions “a” and “b”.
5) Cooling the sole: open the mold to cool the temperature of the sole 20 to normal level.
6) Getting semi-finished products: the semi-finished product of sole 20 with high sidewall 21 and periphery structural pattern 22 is completed.

Based on the above-mentioned procedures, the present invention not only can produce the semi-finished product of sole 20 with high sidewall 21 and periphery structural pattern 22, but also the sole 20 can be integrally formed with preinstalled-material-made special portions (portions “a” and “b”). In this way, the semi-finished product of the sole 20 in accordance with the present invention can be designed in many more different ways. Furthermore, through the procedure 1) Inputting foaming material into mold and pre-calculating accurately the volume percent based on the pre-designed specific gravity of the semi-finished sole and the procedure 2) In-mold foaming, the procedures of air-circulating oven post-cure, second cooling and cutting procedures of conventional foaming process can be omitted, and thus no cutting-wastes produced during operation. The producer needn't to set up recovery device anymore, and thus production cost is substantially reduced.

It is noted that the in-mold foaming process in accordance with the present invention allows the semi-finished sole product 20 with high sidewall 21 and periphery structural pattern 22 to be formed directly in the cavity 11 of the mold 10, thereby sole products with more designs and more functions can be synchronously produced during the foaming procedures, and in this way, the value of the sole 20 is increased.

While we have shown and described various embodiments in accordance with the present invention, it should be clear to those skilled in the art that further embodiments may be made without departing from the scope of the present invention.

1. An in-mold foaming method for making soles, the method comprising the steps of:
1) inputting foaming material (rubber) in mold, wherein a volume percentage of foaming material in cavity of the mold is pre-calculated based on specific gravity;
2) foaming the rubber material in the mold for 4-8 minutes at centigrade 140-150 deg, under pressure 130-150 kg/cm², so as to form the sole directly in the mold cavity;
3) opening the mold and remove the sole so as to cool the foamed sole;
4) completing a semi-finished product of sole.

2. The in-mold foaming method for making soles as claimed in claim 1, wherein before the step 1) inputting foaming material (rubber) in mold, can be added with process for making special portions, which including the procedures as follows:
1) compressing portions “a” and “b” with middle plate: middle plate of the mold initially used to compress the special portions where is preinstalled with raw material into the cavity of the mold;
2) cleaning off the scraps of the raw material after compression: cleaning scraps of raw material off the mold after the special portions are compressed;
3) inputting foaming material in mold;
4) in-mold foaming step: forming the rubber material in a vacuum platform for 5 minutes at centigrade 150 deg under pressure 130-150 kg/cm², such that semi-finished product of sole is formed directly in the cavity of the mold, and the semi-finished product of sole is integrally formed with the special portions;
5) cooling the sole;
6) getting semi-finished products: completing the semi-finished product of sole.

3. The in-mold foaming method for making soles as claimed in claim 1, wherein high sidewall can be synchronously formed on periphery of the sole during the in-mold foaming step.

4. The in-mold foaming method for making soles as claimed in claim 1, wherein periphery structural pattern can be synchronously formed on periphery of the sole during the in-mold foaming step.
